(19) United States
(12) Patent Application Publication
(10) Pub. No.: US 2014/0033983 A1
(43) Pub. Date: Feb. 6, 2014

(54) Fecal Waste Collection Apparatus and Method

(71) Applicant: Alan A. Beatrez, Prior Lake, MN (US)

(72) Inventor: Alan A. Beatrez, Prior Lake, MN (US)

(21) Appl. No.: 13/568,079

(22) Filed: Aug. 6, 2012

(51) Int. Cl. A01K 29/00

(52) U.S. Cl. 119/161

(57) ABSTRACT

Embodiments described herein include an apparatus and method to use a bottomless, animal fecal waste collection device comprising of a low profile, vertical wall that creates a visually identifiable finite space when placed on the ground. The apparatus and method described enables the collection and retention of animal fecal waste without the use of commercially produced litter media because of the placement and use of the device on the ground.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION BY-REFERENCE OF MATERIAL SUBMITTED ON A COMPACT DISC

Not Applicable

### BACKGROUND OF THE INVENTION

A litter box is typically used indoors as a repository for fecal and urine waste deposits from domestic animals such as cats, dogs, rabbits and other pets that naturally or through training will make use of such a repository. The litter box is designed to create a defined area comprised of an open container with vertical sidewalls integrally attached to a bottom member. The litter box is then partially filled with a commercially produced granular absorbent litter media that is used to absorb animal urine, retain fecal matter and aid in minimizing associated odors. When the described litter box is used repeatedly in an indoor environment, it can generate an unpleasant odor. An additional disadvantage to the use of this litter box is the need to periodically purchase and replace the absorbent litter media after it becomes unable to absorb or retain additional animal waste.

Another common practice of pet owners is to allow the animal to deposit fecal waste outdoors allowing the animal to find a self-identified location in which to deposit their fecal excrement. This practice typically results in a yard with multiple droppings of pet fecal matter in random locations which can make it time consuming to locate for removal purposes. Prior to removal the randomly located fecal matter creates a “mine field” in which an unsuspecting person may step on when walking through the yard thereby soiling their shoe or worse yet, their bare foot.

(1) Field of the Invention

Embodiments of the invention relate to an apparatus used to define a discrete area for use by an animal as a fecal waste collection device and a method by which the defined area is used by the animal to deposit fecal matter in the identified, restricted area.

(2) Description Of Related Art Including Information Disclosed Under 37 CFR 1.97 and 1.98

U.S. Patent Documents

| | | |
|---|---|---|
| 4,886,014 | Dec. 12, 1989 | Sheriff |
| 5,148,774 | Sep. 22, 1992 | Fields |
| 5,394,833 | Mar. 7, 1995 | Glass |
| 5,676,090 | Oct. 14, 1997 | Cannady, Jr. |
| 6,039,003 | Mar. 21, 2000 | Cox |
| 6,119,629 | Sep. 19, 2000 | Sicchio |
| 6,298,808 | Oct. 9, 2001 | Crafton |
| 6,415,738 | Jul. 9, 2002 | Hotter |
| 7,748,348 | Jul. 6, 2010 | Jurwitz |

### BRIEF SUMMARY OF THE INVENTION

To overcome the aforementioned disadvantages of managing an animal's fecal excrement and the associated practices, disclosed is a fecal waste collection apparatus and method for use that eliminates the unfavorable aspects of the current litter box products and practices. With the widespread ownership of animals as pets and the aforementioned disadvantageous of current litter containment devices and methods, an improved approach is highly desired.

An embodiment of the present invention includes an apparatus comprised of a vertical wall structure that creates an open top structure without an integrated bottom element. The low profile vertical wall structure creates a visibly defined, finite area to enable an animal to see and recognize the defined space and allow the animal to step over the wall structure to use the device as an alternative to current litter box devices.

Another embodiment of the present invention includes the placement of the device on the ground in an outdoor environment. With the surface of the ground present within the boundaries created by the device, the unique placement of the device eliminates the need for commercially available litter material.

These and other features, aspects, and advantages of the present invention will become better understood with reference to the following description and claims.

### BRIEF DESCRIPTION OF THE SEVERAL VIEWS OF THE DRAWING(S)

FIG. 1 is a perspective view of the fecal waste collection device embodiments of the present invention.

### DETAILED DESCRIPTION OF THE INVENTION

Although detailed embodiments of the invention are disclosed herein, it is to be understood that the disclosed embodiments are merely exemplary of the invention that may be embodied in various and alternative forms. Specific structural and functional details disclosed herein are not to be interpreted as limiting, but merely as a basis for teaching one skilled in the art to variously employ the fecal waste collection device and method embodiments. Within the drawing, like elements are given like numerals.

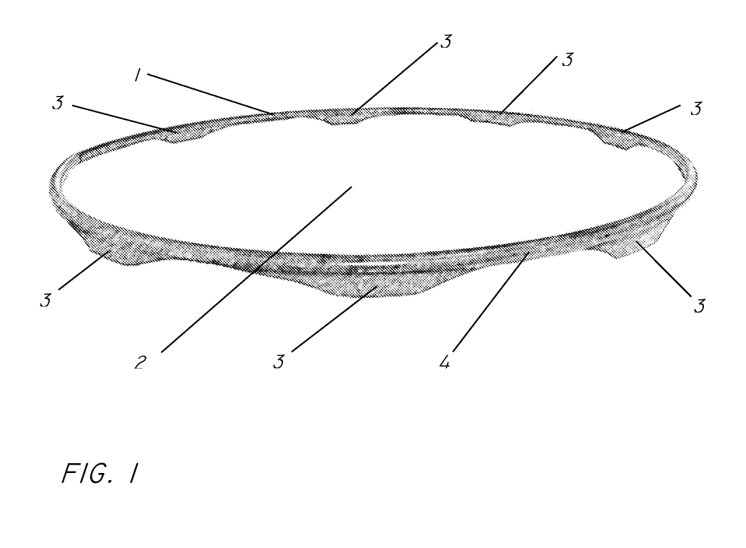

The fecal waste collection device of the present invention, illustrated generally at 1 in FIG. 1 is a device comprising of a vertical wall structure that provides rigidity and overall structural shape to quadrant off a finite amount of outdoor surface area 2 that will be dedicated to the collection of fecal waste from animals trained to use said device. The vertical wall structure which is void of an integrated bottom structure permits the device 1 to be positioned directly on any outdoor surface type including but not limited to grass, soil, sand, snow, concrete or pavement. When the device 1 is positioned on the ground, the surface area 2 is utilized to collect fecal excrement in lieu of using commercially available litter material.

When device 1 is placed on surfaces such as grass, soil, sand or snow which generally are able to be penetrated by a semi-rigid structure, the plurality of downwardly extending wall sections 3 may be used to penetrate the surface it's placed on thereby providing retention to prevent movement of said device.

The vertical wall structure also provides support for an integrated upper body element 4 which provides additional surface area to increase the visibility of the device 1 to animals intending to use it when said device is placed on the ground for use. Although the device is designed to make it visible to animals intending to utilize said device, the overall height of the device at the top of integrated body element 4 is relatively low in profile to permit the using animal to step over the wall structure when necessary, before and after use.

The fecal waste collection device 1 is most preferably made from a material that will withstand extended durations of outdoor elements such as ultraviolet rays from the sun, precipitation and varying outdoor temperatures. The device 1 could be made from a variety of typical materials such as plastic, metal, wood and other generally weather resistant materials.

The aforementioned device and method description is not to be interpreted to exclude other fecal waste containment devices advantageously employing the present invention. Furthermore, it is to be understood that the above-mentioned fecal waste collection device and method is mainly an illustrated embodiment of the principles of this invention and other arrangements and advantages may be derived by those skilled in the art without departing from the spirit and scope of the invention.

What is claimed is:

1. A bottomless, fecal waste collection device comprising of a vertical wall; said vertical wall being low in profile to enable an animal to step over the wall for use of said device.

2. The bottomless animal waste collection device as recited in claim 1, wherein the vertical wall creates a visually identifiable finite space.

3. The visually identifiable finite space recited in claim 2, wherein the created space accommodates the full size of the animal that will use said space as a fecal waste repository.

4. The bottomless, animal fecal waste collection device recited in claim 1, wherein the device sets on the ground.

5. The visually identifiable finite space recited in claim 2, wherein the space is used to collect and retain animal fecal waste without the use of commercially produced litter media.

6. The method of using a bottomless, animal fecal waste collection device comprised of a vertical, low profile wall structure that creates a visually identifiable finite space on the ground.

7. The method of claim 6, wherein the device collects and retains animal fecal waste without the use of commercially produced litter media because of the placement and use of the device on the ground.
